(19) United States
(12) Patent Application Publication
(10) Pub. No.: US 2002/0080774 A1
(43) Pub. Date: Jun. 27, 2002

(54) Methods and systems for interfacing wired/wireless hybrid systems

(75) Inventors: Thomas Griffith, Fairfax, VA (US); Stefan Van Rafelghem, Fairfax, VA (US); Stephen Russell, Fairfax, VA (US); Ronald Hirsch, Fairfax, VA (US)

Correspondence Address: OLIFF & BERRIDGE, PLC, P.O. BOX 19928, ALEXANDRIA, VA, 22320, US

(73) Assignee: AVTEC SYSTEMS, INC., Fairfax, VA

(21) Appl. No.: 09/930,288

(22) Filed: Aug. 16, 2001

Related U.S. Application Data
(60) Provisional application No. 60/231,412, filed on Sep. 8, 2000.

(51) Int. Cl. H04L 12/66

(52) U.S. Cl. 370/352; 370/401

(57) ABSTRACT

Methods and systems are provided to manage communications in networks having wired and wireless portions. By determining the optimum segment size for a wireless link based on various status conditions such as bit-error rates, data throughput across the wireless link can be improved. Accordingly, data received from a wired network can be repackaged using the desired segment size before being transmitted over the wireless link. Similarly, optimum-sized segments can be received from the wireless link and the data in the received segments can be passed to the wired network.

This non-provisional application claims the benefit of U.S. Provisional Application No. 60/231,412 entitled “SECURITY MECHANISMS TO AVERT THREATS IN WIRELESS NETWORK OPERATIONS” filed on Sep. 8,2000 (Attorney Docket No. 105603). The applicants of the provisional application are Ronald HIRSCH, Stefan Van RAFELGHEM, Thomas GRIFFITH and Stephen RUSSELL. The above provisional application is hereby incorporated by reference in its entirety including all references cited therein.

### BACKGROUND OF THE INVENTION

1. Field of Invention

This invention relates to methods and systems for managing communications in networks having wired and wireless portions.

2. Description of Related Art

As global telecommunications networks expand, the need to efficiently interface wired networked systems, such as the Internet, to wireless systems increases commensurately. Unfortunately, most existing wired and wireless systems were developed having different design criteria in mind. As a result, current wired and wireless systems are at best marginally compatible. While various wired/wireless interfaces are currently available to remedy the incompatibility between wired and wireless systems, these interfaces generally must incorporate a large number of compromises. As a result, the wired/wireless interfaces can inadvertently cause excessive delays while transferring data from a wired system to a wireless system. Accordingly, new apparatus and methods that can more efficiently interface wired and wireless systems are needed.

### SUMMARY OF THE INVENTION

The present invention provides methods and systems for optimizing the data transmission rates across wired/wireless interfaces using dynamic segment sizing over the wireless portions of the network. In various embodiments, a technique is described for transferring data from a wired network, such as the Internet, to a wireless device over a wireless link. In operation, a first transmission control protocol (TCP) segment is received from the wired network. The data in the first TCP segment is then extracted and incorporated into one or more second segments suitable for transmitting over a wireless link. To improve data throughput, the size of second segments can be determined based on a status condition associated with the wireless link, such as bit errors, framing errors, signal strength, signal-to-noise ratios and the like.

In other embodiments, a technique is described for transferring data from the wireless link to the wired network. In operation, one or more wireless segments are received from a wireless link. The data in the wireless segments is then extracted and incorporated into one or more wired segments suitable for transmitting over the wired network. Again, to improve data throughput, the size of second segments can be determined based on a status condition associated with the wireless link, such as bit errors, frame errors, signal strength, signal-to-noise ratios and the like.

Other features and advantages of the present invention are described below and are apparent from the accompanying drawings and from the detailed description which follows.

### BRIEF DESCRIPTION OF THE DRAWINGS

The invention is described in detail with regard to the following Figures, wherein like numerals reference like elements, and wherein:

FIG. 1 is a block diagram of an exemplary wired/wireless data network;

FIG. 2 is a block diagram of a first exemplary wireless link according to the present invention;

FIG. 3 is a block diagram of a second exemplary wireless link according to the present invention;

FIG. 4 depicts an exemplary timing diagram of a data transfer and acknowledgment across an error-free wireless link;

FIG. 5 depicts an exemplary timing diagram of a data transfer and acknowledgment across an error-prone wireless link;

FIG. 6 depicts an exemplary timing diagram of a modified data transfer and acknowledgment across an error-prone wireless link using a modified packet format;

FIG. 7 is a block diagram of the data interface of FIG. 1; and

FIG. 8 is a flowchart outlining an exemplary technique for managing communications in a wired/wireless hybrid system.

### DETAILED DESCRIPTION OF PREFERRED EMBODIMENTS

Generally, data networks such as the Internet are controlled by multiple network protocols, which are commonly classified into various layers including a physical layer, a data link layer and a network layer. Because physical systems are imperfect, noise and distortion such as cross-talk, impulse noise, bit-errors and inter-symbol interference (ISI) in a network's physical layer can corrupt data as it traverses the network. As a result, a segment of data traversing a network can be inundated with errors by the time it reaches an intended receiver.

Transmission control protocol (TCP) is a predominant network layer protocol that is used for managing data transfer. TCP transmits data across a network by packaging the data into segments of various predetermined sizes and transporting the data segments using the physical portion of the network. Generally, when the physical portion of network is a wired network, such as a T1, E1 or 10baseT system, the number of errors introduced into a data segment are relatively small.

In contrast, when a network is a wireless network, such as a cellular, microwave or satellite-based communication system, the number of errors introduced into a data segment can be orders of magnitude greater than that of a wired network. As a result, a large data segment suitable for transmission across a wired network may not likely traverse a wireless link without being corrupted. In operation, such large segments may need to be retransmitted numerous times before being successfully delivered to an intended wireless receiver, which can cause excessive delays, and thus, form debilitating bottlenecks across the wireless link.

Furthermore, if a TCP segment takes too long to reach its intended destination, a TCP “time-out” condition can occur. As a result of the TCP time-out, the data contained in the failed segment must not only be retransmitted, but the TCP “window” of a receiving device can be drastically reduced in size. This TCP window-size reduction, in turn, can slow overall data throughput rate and thus, another bottleneck can arise as data is unnecessarily forced to “trickle” across the wired portions of the network.

However, by buffering a TCP segment received from a wired network using an intermediate controller, optionally providing an acknowledgment signal from the controller and then determining the optimum segment size for data traversing a particular wireless link, the received TCP segment can be reformatted into a number of smaller, or otherwise more appropriately sized segments, designed to optimize data throughput across the wireless network. Accordingly, the transfer rate of data across the wired network can be effectively isolated from any errors generated in the wireless link. As a result, the data transfer rate across wired/wireless hybrid networks can be improved as the possibility of excessive numbers of retransmissions and TCP time-outs are reduced.

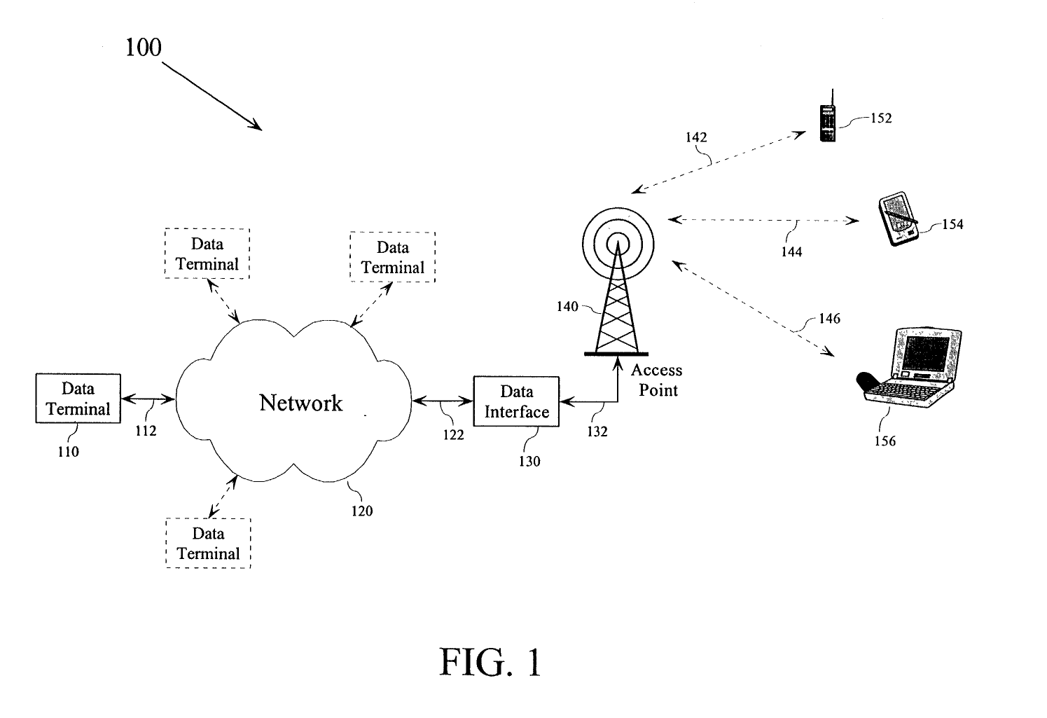

FIG. 1 is a block diagram of an exemplary transmission system 100 having both wired and wireless portions. The transmission system 100 includes a data interface 130 coupled to a data terminal 110 through a network 120, and further connected to an access point 140. The access point 140, in turn, is coupled to a number of wireless devices, such as a cellular phone 152, personal digital assistant (PDA) 154 and a portable computer 156, for example. The wireless devices may be stationary and/or mobile.

In operation, the data terminal 110 can transmit data to and receive data from the network 120 over link 112, which in turn can transmit data to and receive data from the data interface 130 over link 122. The exemplary data terminal 110 can be a personal computer executing Transmission Control Protocol (TCP) operating over Internet Protocol (IP), commonly referred to as TCP/IP. However, the data terminal 110 can also be any one of a number of different types of data sources, such as a computer, a storage device, or any combination of software or hardware capable of generating, relaying, or recalling from storage data capable of being transmitted, directly or indirectly, to a transmission network, or medium, using a network protocol without departing from the spirit and scope of the present invention.

The exemplary network 120 can be a portion of the Internet. However, the network 120 can also be a wide area network or a local area network, an intranet, any subset of the Internet, or any distributed processing network or system. In general, the transmission network 120 can be any known or later developed combination of transmission mediums, computer programs, or structures usable to transmit data between the data source 110 to the data interface 130 without departing from the spirit and scope of the present invention.

Accordingly, the first and second data links 112 and 122 of the exemplary embodiment can be links with the Internet. However, the first and second data links 112 and 122 can also be links on a wide area network or a local area network, an intranet, any subset of the Internet, or links on any distributed processing network or system. In general, the first and second data links 112 and 122 can be any known or later developed transmission medium, computer program, or structure usable to transmit data between the network 120 and the data terminal 110 and data interface 130, respectively, without departing from the spirit and scope of the present invention.

While the exemplary data terminal 110, network 120 and data interface 130 can communicate using TCP, the various devices 110-130 can, in other exemplary embodiments, communicate using other existing communication protocols. Furthermore, because protocols can evolve over time or be replaced in part or in whole, it should be appreciated that the various devices 110-130 can communicate using any known or later developed protocol such as Ethernet or 10baseT or UDP, or variants thereof without departing from the spirit and scope of the present invention. Accordingly, in various embodiments, the term “segment” can include any form of packaged information containing a finite amount of data according to any known or later developed protocol useful for transporting information.

Returning to FIG. 1, as TCP segments are transmitted from the data terminal 110 to the various wireless devices 152-156, the data interface 130, being an intermediate device, can receive the TCP segments and verify that the data in each TCP segment is not corrupted, i.e., contains no non-correctable errors. If the data in a TCP segment is corrupted, the data interface 130 can send an acknowledgment signal to the data terminal 110 indicating that the particular TCP segment was unsuccessfully received and, according to TCP protocol, the data terminal 110 can repeatedly retransmit the TCP segment until the segment is successfully received.

Otherwise, if a particular TCP segment is successfully received, the data interface 130 can buffer the data in the TCP segment and, in various exemplary embodiments, send a signal to the data terminal 110 acknowledging that the TCP segment was successfully received by the data interface 130. While the exemplary data interface 130 can send an acknowledgment signal to the source of a particular segment immediately after reception, it should be appreciated that, in various embodiments, the data interface 130 can first deliver the data in a received segment to an intended destination, such as one of the wireless devices 152-156, confirm successful delivery to the wireless device 152, 154 or 156 and then return an acknowledgment signal to the data terminal 110.

As the data interface 130 communicates with the data terminal 110, the data interface 130 can simultaneously communicate with the access point 140 and the wireless devices 152-156. That is, the data interface 130 can transmit data to and receive data from the access point 140 via link 132. Furthermore, the access point 140 can relay information to and from the wireless devices 152-156 via wireless links 142-146 respectively.

The third data link 132, like the first and second data links 112 and 122, can be any known or later developed device or system for connecting the data interface 130 to the access point 140. Such devices include direct serial/parallel cable connections, wireless connections, satellite links, connections over a wide area network or a local area network, connections over an intranet, connections over the Internet, or connections over any other distributed processing network or system. Additionally, the third data link 132 can be software devices linking various software systems. In general, the third data link 132 can be any known or later developed connection system, computer program, or structure usable to transport data between the data interface 130 and the access point 140.

The exemplary access point 140 is a wireless transmitter/receiver capable of transmitting and receiving various radio signals according to a CDMA or GSM based protocol. However, the access point 140 alternatively can be any one of a number of different devices, such as a radio-frequency (RF) or microwave wireless transmitter/receiver, a transmission/reception system employing wires such as a twisted wire pair, a transmitter/receiver adapted for transmitting across coaxial cable, an optical transmitter/receiver, a fiber-optic transmitter/receiver, a sonic transmitter/receiver or any other known or later developed device suitable for transmitting/receiving data. Accordingly, the wireless devices 152-156 can be any number of devices capable of communicating with the access point 140 including specially adapted computer-based systems, cellular phones, PDAs and the like.

In addition to sending and receiving data to/from the wireless devices 152-156, the data interface 130 can receive status information generated by the access point 140 and/or generated by the various wireless devices 152-156. Additionally, the data interface 130 can extract or otherwise derive other status information from segments received from the wireless devices 152-156.

For example, in various embodiments, the access point 140 and the wireless devices 152-156, alone or in combination, can measure various status conditions associated with their respective links 142-146 as they receive communication signals from the access point 140. For instance, a wireless device can measure various parameters associated with the physical-layer of its wireless link with a particular access point, such as the strength of a radio signal received by the wireless device, a signal-to-noise ratio (SNR), a signal-to-interference ratio (SI), a signal-to-interference-plus-noise ratio (SINR), the impulse response/transfer function of the wireless link or any other parameter conceptually associated with a wireless signal, such as a CDMA, TDMA or like radio signal without departing from the spirit and scope of the present invention.

In other exemplary embodiments, a wireless device can measure various status conditions associated with the data-link layer of a wireless link with a particular access point including bit-error rates (BER), octet/byte errors, frame or multi-frame errors, synchronization errors, loss of signal or any other parameter conceptually associated with a data-link layer without departing from the spirit and scope of the present invention.

In still other exemplary embodiments, a wireless device can measure various status conditions associated with the network layer of a wireless link such as a number of erroneous, i.e., corrupted, segments, time-out errors, echo request errors, unknown or erroneous message errors, “ping” errors or any other parameter conceptually associated with a network layer without departing from the spirit and scope of the present invention.

As a particular wireless device 152, 154 or 156 performs its various status/error measurements, the particular wireless device 152, 154 or 156 can report any number of determinable status conditions or derivative information to the data interface 130 through the access point 140.

The access point 140, in addition to relaying status condition information derived by the wireless devices 152-156, can similarly perform similar status condition measurements for signals received from the wireless devices 152-156. Once the access point 140 has measured the various status conditions for a particular wireless link 142, 144 or 146, the access point 140 can report this status condition information both to the data interface 130 and to the respective wireless device 152, 154 or 156.

Once the data interface 130 has received the appropriate status condition information for a particular wireless link 142, 144 or 146, the data interface 130 can determine a number of operational parameters designed to optimize or otherwise improve data throughput based on the status information. That is, as the data interface 130 receives a TCP segment from the data terminal 110, the data interface 130 can repackage the data in the received TCP segment, based in part or in whole on the status information, into a form more suitable for transmission across the wireless link 142, 144 or 146.

For example, if status information associated with a particular wireless link 142, 144 or 146 indicates that the wireless link 142, 144 or 146 is likely to introduce relatively few errors into a communication signal traversing a wireless link 142, 144 or 146, the data interface 130 can pass TCP segments received from the network 120 to a respective wireless device 152, 154 or 156 without modification. If the TCP segments received from the network 120 are small, the data interface 130 can even aggregate the data in the received segments and pass larger-sized segments to the respective wireless device 152, 154 or 156.

In contrast, however, if status information associated with a particular wireless link 142, 144 or 146 indicates that the wireless link 142, 144 or 146 is likely to introduce errors, or if the status information indicates a trend that a particular wireless link 142, 144 or 146 is becoming increasingly susceptible to errors, it should be appreciated that the data interface 130 can repackage the data received from the network 120 in smaller-sized segments and have the smaller-sized segments transmitted over the wireless link 142, 144 or 146.

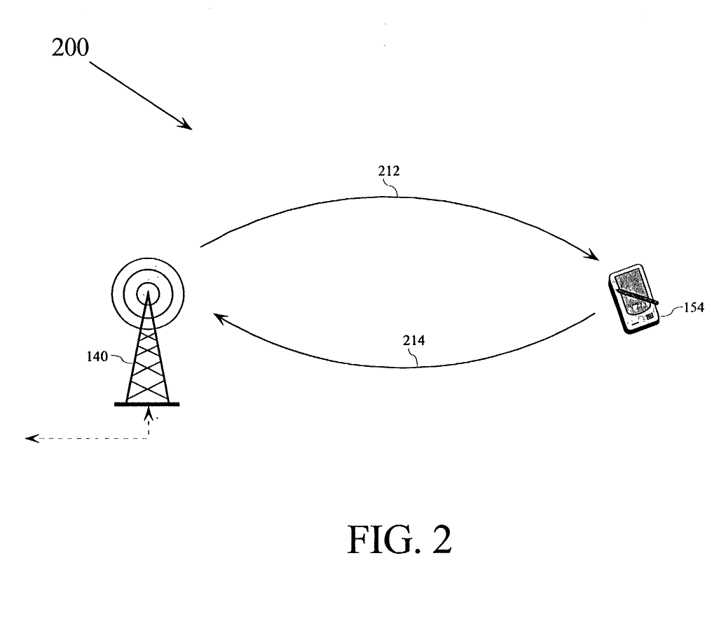

FIG. 2 is an exemplary cellular wireless link 200 between an access point 140 and a PDA 154 having a wireless transmitting/receiving device. As shown in FIG. 2, the wireless link 200 has an outgoing channel 212 and an incoming channel 214. In operation, the outgoing channel 212 can carry various forms of information to the PDA 154, such as data derived from a network (not shown) and status information measured by the access point 140. Similarly, the incoming channel 214 can carry various forms of information to the access point 140, such as data derived from a network (not shown) and status information measured or otherwise determined by the PDA 154.

The exemplary channels 212 and 214 are radio-frequency CDMA continuous signals modulated according to a quadrature amplitude modulation (QAM) technique. However, it should be appreciated that, in various exemplary embodiments, the channels 212 and 214 can alternatively take various other known or later developed forms, such as time division multiple access (TDMA) channels, and can be modulated according to any other known or later developed technique, such as a frequency modulation (FM) technique, without departing from the spirit and scope of the present invention.

If an exemplary channel's physical layer is a continuous channel, then it should be appreciated that segments traversing the channel can be modified in size without affecting the characteristics of the physical layer of the channel 212 or 214. For example, a data interface can modify outgoing segments from 16,000 bits to 4,000 bits without causing the access point 140 to change the CDMA communication scheme or respective modulation technique. Similarly, if an exemplary channel's physical layer uses burst signals, such as an IS-136 channel, segments can be transported between the PDA 154 and access point 140 using burst signals having a constant size.

However, in various embodiments, if an exemplary channel's physical layer uses burst signals, then a segment size and burst signal size can be operationally merge. That is, the access point 140 and/or the PDA 154 can adjust the size of the burst signals traversing link 200 in response to changing status conditions, with each burst sized to carry a segment of data.

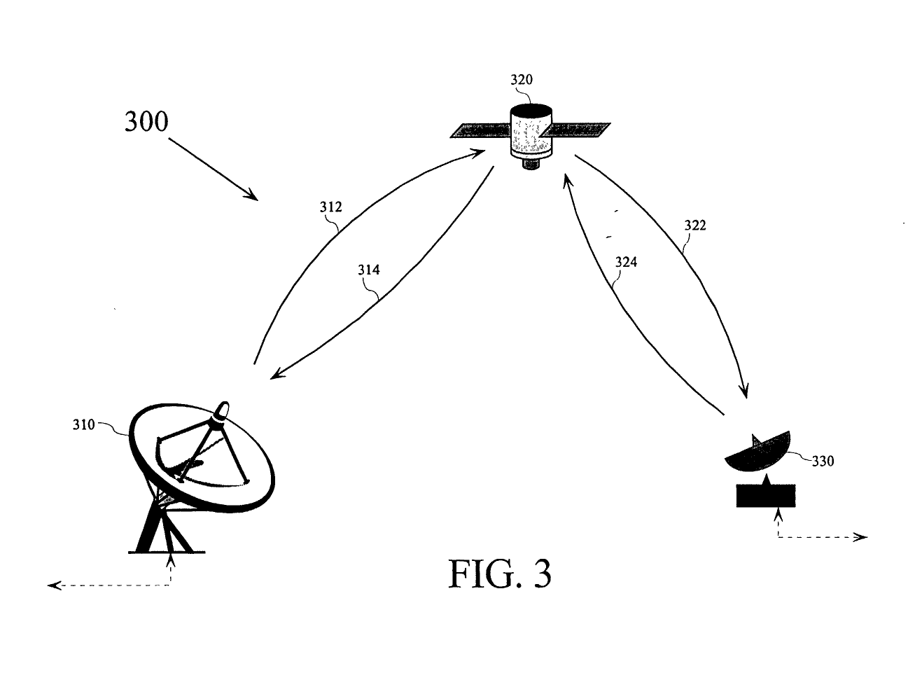

FIG. 3 is an exemplary satellite-based link 300 between an access point 310 and a remote wireless device 330 using one or more intermediate satellite(s) 320. As shown in FIG. 3, there is a first wireless link between the access point 310 and the satellite 320 consisting of a first outgoing channel 312 and a first incoming channel 314. Further, there is a second wireless link between the satellite 320 and the remote wireless device 330 consisting of a second outgoing channel 322 and a second incoming channel 324.

In operation, the access point 310 can transmit data, status and other information to the remote wireless device 330 via the first and second outgoing channels 312 and 322. Similarly, the remote wireless device 330 can transmit data, status and other information to the access point 310 via the second and first incoming channels 324 and 314.

As with FIG. 2, the access point 310 and remote wireless device 330 can measure various status conditions and manipulate segment size based on the measured status conditions. In various exemplary embodiments, the satellite 320 can act as a simple transceiver relaying signals. However, in various other embodiments, it should additionally be appreciated that the satellite 320 can measure various status conditions and manipulate segment size based on the measured status conditions.

For example, based on status conditions measured by the satellite 320 associated with channel 312 and relayed to the access point 310 using channel 314, a controller (not shown) can receive segments of 32,000 bits from a network, repackage the data into 4,000-bit segments and relay the 4,000-bit segments to the satellite via the access point 310. The satellite 320, in turn, can optionally repackage the 4,000-bit segments into 500-bit segments based on status conditions measured by the remote wireless device 330 associated with channel 322 and relayed using channel 324. Similarly, the satellite 320 can relay/repackage data from the remote wireless device 330 to the access point 310.

The exemplary satellite-based link 300 can be a TRDSS-based communication link. However, in various embodiments, it should be appreciated that the satellite-based link 300 can be based on any known or later developed satellite communication system such as INTELSAT, INMARSAT and the like without departing from the spirit and scope of the present invention.

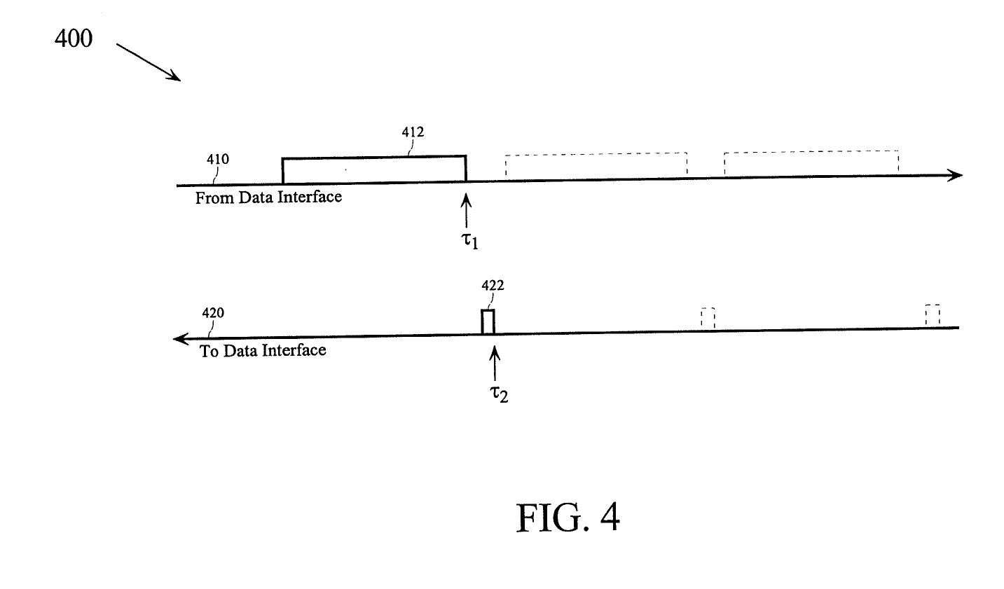

FIG. 4 depicts an exemplary timing diagram of an error-free wireless link 400. The wireless link 400 includes an outgoing channel 410 capable of carrying data segments and various other signals from a controller/access point to a wireless device, and an incoming channel 420 capable of data segments and various other signals from the wireless device back to the data interface/access point.

As shown in FIG. 4, the outgoing channel 410 can transport an outgoing segment 412. Because the outgoing channel 410 is error-free, the outgoing data segment 412 can be received by the wireless device without being corrupted, and therefore the outgoing data segment 412 can be successfully received by the wireless device by time τ₁.

After the outgoing data segment 412 is successfully received, the wireless device can send an incoming acknowledgment signal 422 signaling to the data interface that the outgoing data segment 412 was successfully received. Accordingly, an exchange of data with an appropriate acknowledgment can be completed by time τ₂.

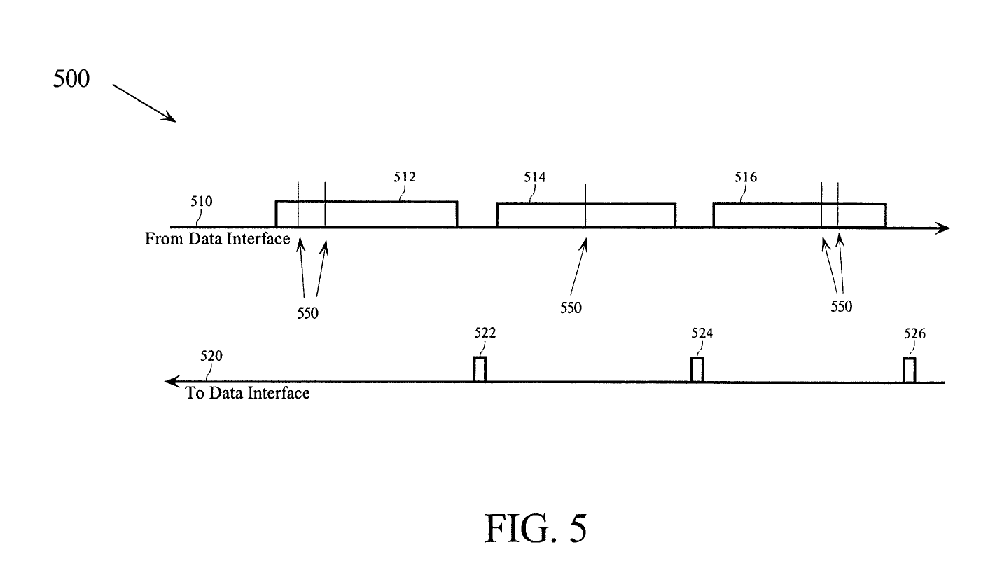

FIG. 5 depicts an exemplary timing diagram of an error-prone wireless link 500. The wireless link 500 includes an outgoing channel 510 capable of carrying data segments and various other signals from a data interface/access point to a wireless device, and an incoming channel 520 capable of carrying data segments and various other signals from the wireless device back to the data interface/access point.

Like the error-free link 400 of FIG. 4, the channels 510 and 520 of the error-prone link can contain data segments and other information, such as acknowledgment signals. However, unlike the error free link 400, the various outgoing data segment 512, 514 and 516 can be corrupted by a number of bit-errors 512.

In the exemplary timing diagram, the data interface/access point can send a first outgoing data packet 512. Because the first outgoing data segment 512 contains two bit-errors 550, the receiving wireless device will not successfully receive the first outgoing data segment 512 assuming that the first outgoing data segment 512 has an error detection capacity, but no error correction capacity, such as with TCP segments. Accordingly, the wireless device can return a first acknowledgment signal 522 indicating that the first outgoing data segment 512 was unsuccessfully received.

In response to the first failure acknowledgment signal 522, the data interface/access can retransmit the second outgoing data packet 514, which can be identical to the first outgoing data packet 512, in an attempt to complete the data transfer. Because the second outgoing data packet 514 is also corrupted, the wireless device can return a second acknowledgment signal 524 indicating that the second outgoing data segment 514 was unsuccessfully received.

In response to the second failure acknowledgment signal 524, yet another outgoing data packet 516 and acknowledgment signal 526 can be sent. The outgoing data can be repeatedly retransmitted until an outgoing data segment is successfully received and acknowledged by the wireless device. However, as discussed above, if a status condition such as a BER increases, it should be appreciated that the likelihood that segments of a particular size will successfully be transmitted can decrease until so many retransmissions are required that timely delivery of data is statistically unlikely.

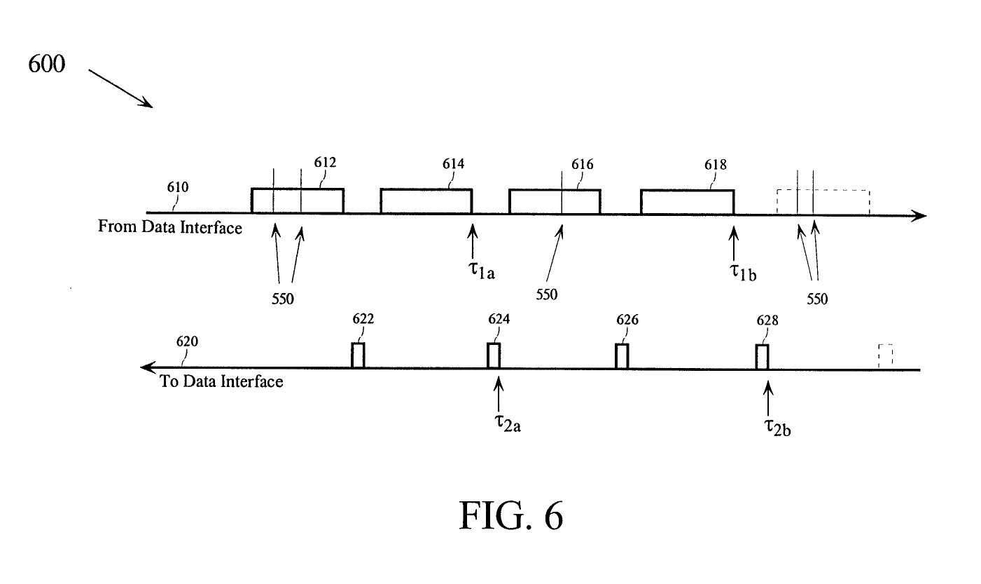

FIG. 6 depicts an exemplary timing diagram of a second error-prone wireless link 600. The second wireless link 600 includes an outgoing channel 610 capable of carrying data segments and various other signals from a data interface/access point to a wireless device, and an incoming channel 620 capable of carrying data segments and various other signals from the wireless device back to the data interface/access point.

Like the first error-prone link 500 of FIG. 5, the outgoing channel 610 of the second error-prone link 600 can contain data segments corrupted by errors. However, unlike the first error-prone link 500, the outgoing data segments 612-618 contain half the data of the outgoing data segments of FIG. 5. Accordingly, for equivalent data to be transferred, two smaller outgoing segments must be successfully received and acknowledged, as opposed to a single segment as with FIGS. 4 and 5.

In the exemplary timing diagram, the data interface/access point can send a first outgoing data packet 612. Because the first outgoing data segment 612 contains two bit-errors 550, the first outgoing data segment 612 will fail and the wireless device can return a first failure acknowledgment signal 622.

In response, the data interface/access point can retransmit the data of the first outgoing data segment using the second outgoing data segment 614. As shown in FIG. 6, because the second outgoing data segment 614 contains no errors, it can be successfully received by the wireless device by time τ₁ₐ and appropriately acknowledged with signal 624 by time τ_{1b}.

Next, the data interface/access point can transmit a second block of data using a third outgoing data segment 616. Because the third outgoing data segment 616 contains a bit-error 550, the wireless device can again return a respective failure acknowledgment signal 626. In response, the data interface/access point can retransmit the second block of data using the forth outgoing data segment 618 and, as shown in FIG. 6, because the forth outgoing data segment 618 contains no errors, it can be successfully received by the wireless device by time τ_{1b} and appropriately acknowledged with signal 628 by time τ_{2b}.

FIGS. 5-6 demonstrate that the rate of data transfer can be improved in noisy environments using multiple smaller data segments, as opposed to a single large data segment. Although parsing and transmitting data in smaller packets can potentially take longer than transmitting the equivalent amount of data in a single large packet, the smaller-sized segments can nonetheless increase the likelihood that data will be timely delivered and acknowledged in error-prone environments since the likelihood that each small segment will be successfully transmitted is greater.

For example, if a segment contains 32,000 bits and the BER of a respective communication channel is 1×10⁻⁴, then the probability that the 32,000-bit segment will be successfully received is (1−1×10⁻⁴)^{32,000}=0.9999³²⁰⁰⁰⁰=4.07%, assuming a binomial distribution. That is, each 32,000-bit segment will typically be retransmitted about twenty-five times on average and, thus 96% of the potential data capacity of the communication channel will likely be wasted.

However, if the same data stream used 4,000-bit segments, then the probability that each 4,000-bit segment will be successfully received is (1−1×10⁻⁴)^{4,000}=0.9999⁴⁰⁰⁰=67%. Accordingly, only 33% of the potential data capacity of the communication channel is wasted. Although some efficiency is lost due to the use of smaller segments, each requiring a separate acknowledgment signal, the overall increases the rate of data transfer is higher, and thus the potential for other error-conditions such as time-out errors is decreased.

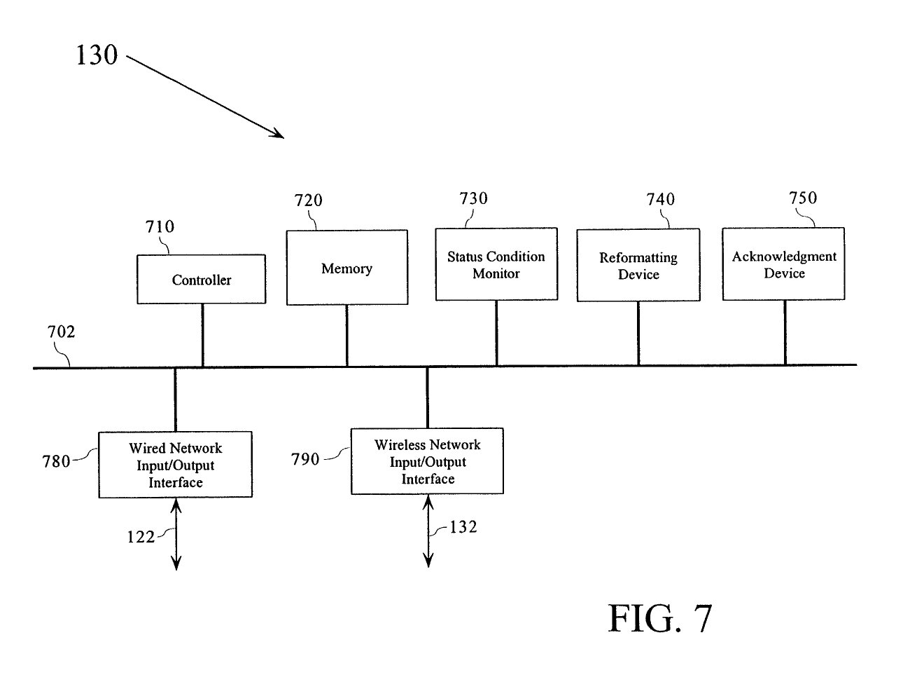

FIG. 7 is a block diagram of the data interface 130 of FIG. 1. The data interface 130 includes a controller 710, a memory 720, a status condition monitor 730, a reformatting device 740, an acknowledgment device 750, a wired network input/output interface 780 and a wireless network input/output interface 790. The above components are coupled together by control/data bus 702. Although the exemplary controller 120 uses a bussed architecture, it should be appreciated that any other architecture may be used as is well known to those of ordinary skill in the art.

In operation, and under control of the controller 710, the wired network input/output interface 780 can receive a number of TCP segments from a wired network (not shown) via link 122, and provide the segments to the memory 720 and to the acknowledgment device 750.

For each received segment, the acknowledgment device 750 can determine whether the data in the segment is corrupted. If the data in a particular segment is corrupted, then the acknowledgment device 750 can purge the corrupted segment from the memory 720 and send an acknowledgment signal to the source of the segment indicating that the particular segment is corrupted.

However, if a segment is valid, then the acknowledgment device 750 can send an acknowledgment signal to the controller 710 and the source of the segment indicating that the particular segment is valid. The controller 710 can then extract the data and the destination address of the received segment and store this information in the reformatting device 740.

Additionally, under the control of the controller 710, the wireless network input/output interface 790 can receive a number of wireless segments and status condition information associated with various wireless links via link 132, and store the status condition information in the memory 720 and status condition monitor 730.

The status condition monitor 730 can receive the status condition information and determine the optimum or an otherwise advantageous size for segments traversing each wireless link monitored. As discussed above, the status information can include any combination of information relating to the performance of a wireless link such as a BER, an SNR, an SINR and the like without departing from the spirit and scope of the present invention. Furthermore, as discussed above, the status condition monitor 730 can derive other status and error information from the received wireless segments. For example, the status condition monitor 730 can receive a segment from a wireless device and determine whether the segment contains various bit or octet errors.

In various embodiments, as the status condition monitor 730 receives status condition information, the status condition monitor 730 can determine a desired wireless segment size based on the latest status condition information received. In other embodiments, the status condition monitor 730 can assess the desired wireless segment size based on trends of changing status conditions. However, it should be appreciated that the particular formula and weight that each status/error condition takes in determining the desired segment size can vary without departing from the spirit and scope of the present invention. Once the status condition monitor 730 determines the desired segment size for a particular wireless link, the status condition monitor 730 can provide this information to the reformatting device 740.

The reformatting device 740 can receive the data and destination address of the received segment, as well as the desired segment size for the wireless link associated with the destination address, and package the data and address information in the appropriate-sized segments. The reformatting device 740 can then provide the repackaged segments to the intended wireless device via the wireless network input/output device 790 and link 132.

For each segment sent by the reformatting device 740, it should be appreciated that a respective acknowledgment signal should be received from the intended destination. If the respective acknowledgment signal indicates successful reception of the segment, then the wireless segment can be considered successfully transferred and the data interface 130 can repackage and forward another segment to the wireless device.

However, if the respective acknowledgment signal indicates unsuccessful reception of the segment, or if no acknowledgment signal is received, then the data interface 130 can optionally repackage the data into segments of a different size based on further status information, and retransmit the segment(s) to the wireless device. The process can continue until the segment(s) are successfully acknowledged or until the controller 710 determines that any further retransmissions are inappropriate, too much time has elapsed or the controller 710 decides to terminate the process based on any other operative parameter.

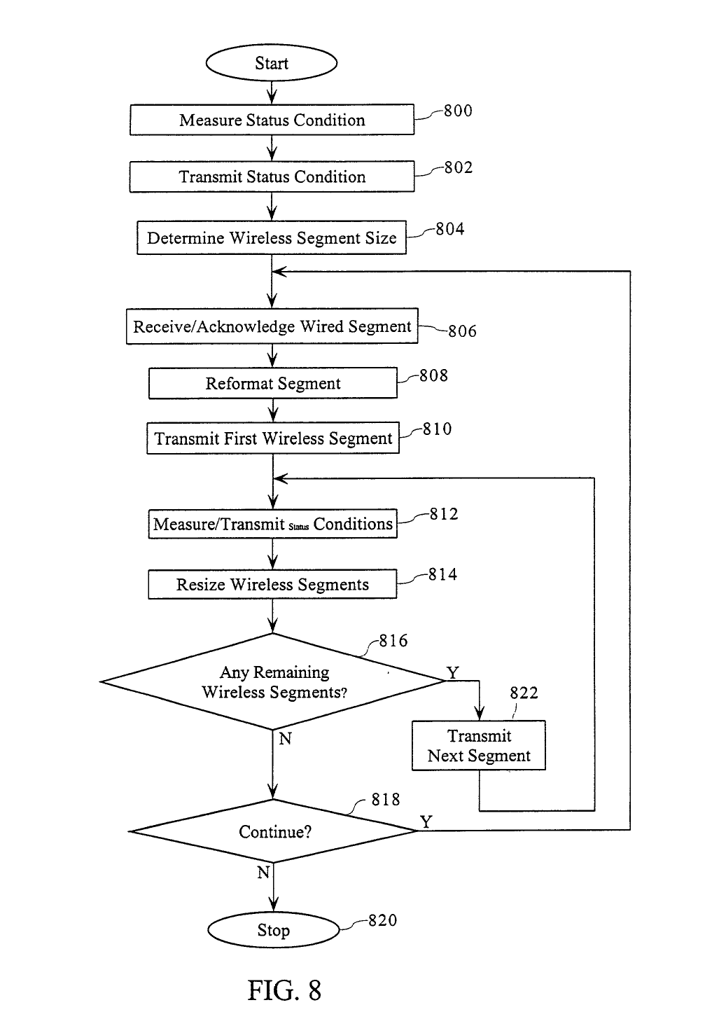

FIG. 8 depicts a flowchart outlining an exemplary process for adaptively transmitting information from a controller to a wireless device such as a cellular or satellite-based communication system. The process starts at step 800 where a number of status conditions are measured. As discussed above, the status conditions can take various forms and can include BERs, SNRs, SINRs, framing errors and the like without departing from the spirit and scope of the present invention. Furthermore, as discussed above, the status conditions can be measured or otherwise determined by various remote wireless devices and/or a local access point as well as any other device capable of measuring/determining status information associated with various wireless links without departing from the spirit and scope of the present invention. Next, in step 802, the various status information can be transmitted to a controller. The process continues to step 804.

In step 804, a desired wireless segment size can be determined based on the various status condition information. Next, in step 806, a segment of data can be received and appropriately acknowledged from a wired network such as the Internet. Then, in step 808, the data in the received segment can be reformatted, i.e., repackaged into one or more segments of the size determined in step 804. The process continues to step 810.

In step 810, the first segment packaged in step 808 is transmitted to the intended wireless destination. Next, in step 812, further status conditions can be measured/determined and transmitted to a controller. For example, as the first segment is transmitted on an outgoing link, the intended receiver can measure various status conditions associated with the outgoing link and transmit the status condition information using a complementary incoming link. The process continues to step 814.

In step 814, the preferred size of the wireless segments can again be determined or otherwise adjusted. For example, if the status condition information determined in step 814 indicate that the wireless link carrying the segment of step 810 is becoming more prone to errors, then the desired size of the wireless segments can be reduced. Next, in step 816, a determination is made as to whether any further segments generated in step 808 remain. If there are no remaining segments, then control continues to step 818; otherwise, control jumps to step 822.

In step 822, the next segment generated in step 808 is transmitted and control jumps back to step 812, where further status conditions can be measured/determined and transmitted to a controller. Steps 812-816 and 822 can then be repeated until none of the segments generated in step 808 remain.

In step 818, a determination is made whether to continue to transfer data. If no further data is to be transferred, then control continues to step 820 where the process stops; otherwise, control jumps back to step 806 where further segments can be received from the wired network. Steps 806-822 can then be repeated until a determination is made to discontinue the process.

As shown in FIG. 7, the methods of this invention are preferably implemented using a general purpose computer such as a personal computer with peripheral integrated circuit elements and dedicated communication hardware. However, the data interface 130 can be implemented using any combination of one or more programmed special purpose computers, programmed microprocessors or micro-controllers and peripheral integrated circuit elements, ASIC or other integrated circuits, digital signal processors, hardwired electronic or logic circuits such as discrete element circuits, programmable logic devices such as a PLD, PLA, FPGA or PAL, or the like. In general, any device capable of implementing a finite state machine that is in turn capable of implementing the flowchart shown in FIG. 8 can be used to implement the data interface 130.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. Thus, there are changes that may be made without departing from the spirit and scope of the present invention.

What is claimed is:

1. A method for communicating, comprising:
receiving a first segment from a wired network; and
transmitting one or more second segments over a wireless link, wherein the one or more second segments contain data from the first segment, and wherein the size of at least one of the second segments is based on a status condition.

2. The method of claim 1, wherein the status condition is associated with the wireless link.

3. The method of claim 2, wherein the wireless link is based on a continuous communication technique.

4. The method of claim 2, wherein the wireless link is based on a burst communication technique.

5. The method of claim 2, wherein the status condition is received from an access point associated with the wireless link.

6. The method of claim 2, wherein the status condition is received from a wireless device associated with the wireless link.

7. The method of claim 2, further comprising sending an acknowledgment for the first segment over the wired network before the data contained in the first segment is received by a wireless receiver.

8. The method of claim 2, wherein at least one of the first segment and the second segment is based on transmission control protocol (TCP).

9. The method of claim 2, wherein the status condition is based on at least a bit-error rate.

10. The method of claim 2, wherein status condition is based on at least a number of erroneous frames.

11. The method of claim 2, wherein status condition is based on at least a signal level associated with the wireless link.

12. The method of claim 11, wherein status condition is further based on at least one of a noise level associated with the wireless link and an interference level associated with the wireless link.

13. The method of claim 2, wherein status condition is further based a rate of change of an error parameter.

14. The method of claim 2, wherein the wireless link is a cellular link.

15. The method of claim 2, wherein the wireless link is a satellite-based link.

16. An apparatus for communicating between a wired network and a wireless link, comprising:
a second interface coupled to the wireless link, wherein the second device communicates using wireless segments; and
a segment controller that controls the size of at least one wireless segment based on a status condition.

17. The apparatus of claim 16, wherein the status condition is associated with the wireless link.

18. The apparatus of claim 17, further comprising a first interface coupled to the wired network, wherein the first device communicates using wired segments.

19. The apparatus of claim 18, further comprising a reformatting device that extracts data from a first wired segment and incorporates the wired data into one or more first wireless segments.

20. The apparatus of claim 19, wherein the reformatting device extracts data from a second wireless segment and incorporates the wireless data into one or more second wired segments.

21. The apparatus of claim 18, further comprising a reformatting device that extracts data from a second wireless segment and incorporates the wireless data into one or more second wired segments.

22. The apparatus of claim 18, further comprising an acknowledgment device that acknowledges a first wired segment received from the wired network before the data contained in the first wired segment is received by a wireless receiver.

23. The apparatus of claim 18, wherein the first interface communicates based on at least transmission control protocol (TCP).

24. The apparatus of claim 18, wherein the second interface communicates based on at least transmission control protocol (TCP).

25. The apparatus of claim 18, wherein the status condition is based on at least a bit-error rate.

26. The apparatus of claim 18, wherein status condition is based on at least a number of erroneous frames.

27. The apparatus of claim 18, wherein status condition is based on at least a signal level associated with the wireless link.

28. The apparatus of claim 27, wherein status condition is further based on at least one of a noise level associated with the wireless link and an interference level associated with the wireless link.

29. The apparatus of claim 18, wherein status condition is further based on a status condition trend.

30. A method for communicating between a first network and a second network, comprising:
receiving first data from the first network; and
transforming the first data into second data having a second format, wherein the second format is based on a status condition of the second network.

31. The method of claim 30, further comprising transmitting the second data to a receiving device associated with the second network.

32. The method of claim 31, wherein the status condition is received from the receiving device.

33. The method of claim 32, wherein the status condition is based on an outgoing channel associated with the receiving device.

34. The method of claim 33, wherein the second network is a wireless network.

35. The method of claim 34, further comprising receiving an acknowledgment from the receiving device.

36. The method of claim 34, wherein at least one of the first format and the second format is based on transmission control protocol (TCP).

37. An apparatus for communicating between a first network and a second network, comprising:
a first interface that receive first data from the first network; and
a reformatting device that transforms the first data into second data having a second format, wherein the second format is based on a status condition of the second network.

38. The apparatus of claim 37, further comprising a second interface that transmits the second data to a receiving device associated with the second network.

39. The apparatus of claim 38, wherein the status condition is received from the receiving device.

40. The apparatus of claim 39, wherein the status condition is based on an outgoing channel associated with the receiving device.

41. The apparatus of claim 40, wherein the second network is a wireless network.

42. The apparatus of 41, further comprising an acknowledgment device that receives an acknowledgment from the receiving device.

43. The apparatus of claim 41, wherein at least one of the first format and the second format is based on transmission control protocol (TCP).

44. Segmenting the end-to-end link into wireless and wired links and isolating the performance of the wireless link from the performance of the wired links using the apparatus of claim 37 on both sides of the wireless link.
